(19) United States
(12) Patent Application Publication
(10) Pub. No.: US 2013/0099423 A1
(43) Pub. Date: Apr. 25, 2013

(54) PHOTOCURABLE COMPOSITION FOR IMPRINT AND METHOD FOR FORMATION OF PATTERN USING THE COMPOSITION

(71) Applicants: Hideki Umekawa, Tsukuba-shi (JP); Yuichiro Kawabata, Tsukuba-shi (JP)

(72) Inventors: Hideki Umekawa, Tsukuba-shi (JP); Yuichiro Kawabata, Tsukuba-shi (JP)

(73) Assignee: TOKUYAMA CORPORATION, Yamaguchi (JP)

(21) Appl. No.: 13/808,036

(22) PCT Filed: Jun. 29, 2011
(86) PCT No.: PCT/JP2011/064868

§ 371 Date: Jan. 2, 2013

(30) Foreign Application Priority Data
Jul. 2, 2010 (JP) 2010-152365

(51) Int. Cl. C08F 267/06; B29C 59/16

(52) U.S. Cl. CPC C08F 267/06; B29C 59/16
USPC 264/496; 522/123

(57) ABSTRACT

Disclosed is a photocurable composition for imprint which has good pattern-transferring property and good detachability from mold (pattern formation surface) regardless of the type of polymerizable monomer to be used, whereby it is possible to form a pattern having a shape with excellent reproducibility; and a method for forming a pattern on a substrate by photoimprint using the composition. The photocurable composition for imprint includes (A) polymerizable monomer having (meth)acrylic group, (B) photoinitiator, and (C) hyperbranched polymer obtained by polymerizing polymerizable monomer having (meth)acrylic group. Preferably, the composition includes 0.1-10 parts by mass of the photoinitiator (B) and 0.1-10 parts by mass of the hyperbranched polymer (C) relative to 100 parts by mass of the polymerizable monomer (A).

### TECHNICAL FIELD

The present invention relates to a novel photocurable composition for imprint (hereinafter, it is referred to as “photocurable imprint composition”) and also to a novel method for forming a pattern on a substrate using said photocurable imprint composition.

### BACKGROUND ART

Recently, there is a demand for reduction of the feature size and high precision on a semiconductor integrated circuit and the fine and high-precision semiconductor integrated circuit is generally prepared by imprint technology.

The imprint technology is a technology for transferring a desirable pattern to surface of a substrate by pressing a mold on which dents and dings of pattern corresponding to the desirable pattern to be formed on the substrate are formed against a coating film which is formed on the surface of the substrate. Utilizing this technology, it is possible to form a nano-scale fine pattern. Among the imprint technologies, the technology for forming an ultrafine pattern having size of several hundreds to several nanometer (nm) is especially referred as nanoimprint technology.

On the imprint technology, the method for forming a pattern is classified roughly into two types depending on type of material used for forming the coating film on surface of mold. One type is a method for transferring a pattern to coating film, which comprises steps of heating the coating film formed on the surface of the substrate to plasticize, of pressing a mold against the coating film, and of cooling the coating film to solidify. Another type is a method in which at least one of used mold and substrate is made of light-permeable material and a pattern is transferred by steps of applying a photocurable composition in the form of liquid to a substrate to form a coating film, of pressing the mold against the coating film, and of irradiating the coating film with light through the mold or the substrate to cure the coating film. Among them, the photoimprint method in which the patter is transferred via photoirradiation has widely been used in the nanoimprint technology, because it is possible to form a high-precision pattern. Many photocurable compositions which can suitably be used in the photoimprint method have been developed.

For example, many photocurable compositions for nanoimprint (hereinafter, it is referred to as “photocurable nanoimprint composition”) in which polymerizable monomer having (meth)acrylic group is used have been developed (see Patent Literatures 1-6). The polymerizable monomer having (meth)acrylic group is easily photopolymerized and is used suitably for forming a several tens nano-scale pattern. But, in practice, various polymeirizable monomers are used in combination, because the photocurable composition is required to provide various performances.

Specifically, it is known that in the photocurable nanoimprint composition which is used in the photo-nanoimprint technology, polymerizable monomers which have different copolymerization property from each other are used in combination in order to improve the adhesion to substrate and lower the adhesiveness to mold (see Patent Literature 1). The photocurable nanoimprint composition in which a polymerizable monomer having cyclic structure in molecule is compounded at a specific amount with respect to other ingredients in order to enhance the resistance to dry etching has been known (see Patent Literature 2). Additionally, the photocurable nanoimprint composition in which a reactive diluent (polymerizable monomer) is compounded in order to improve the fluidity has also been known (see Patent Literature 3).

As described above, since each polymerizable monomer has its role, it is necessary to control the blending ratio depending on a pattern to be formed. Recently, the demand for the photocurable nanoimprint composition which is used for the nanoimprint technology becomes severe. Especially, it is required to manufacture a substrate having a high-precision and ultrafine pattern and as the pattern is, for this purpose, further refined, it is demanded to maintain good shape of ultrafine pattern prepared by curing the photocurable nanoimprint composition. There are many ways to satisfy the demands. Among them, it is strongly required to develop a photocurable nanoimprint composition having various characteristics such as good pattern-transferring property from mold (pattern-forming surface), excellent photocurable property, low adhesiveness to mold, excellent detachability from mold.

In the developments of the photocurable nanoimprint composition, as described above, various trials by controlling type of polymerizable monomer to be used or its blending amount have been conducted. However, since respective polymerizable monomers have individually a specific role, it is extremely difficult to accomplish various performances which are demanded for the photocurable nanoimprint composition by controlling merely combination of polymerizable monomers to be used, blending amount. Therefore, if the above-described performances of the photocurable nanoimprint composition are improved by additives regardless the polymerizable monomer to be used, the photocurable nanoimprint composition can widely be used in manufacture of a substrate having various ultrafine pattern or various types of usage and their applicability is remarkably improved.

### CITATION LIST

### Patent Literature

Patent Literature 1: Japanese Paten Laid-open No. 2008-84984

Patent Literature 2: Japanese Paten Laid-open No. 2007-186570

Patent Literature 3: Japanese Paten Laid-open No. 2007-84625

Patent Literature 4: Japanese Paten Laid-open No. 2010-17936

Patent Literature 5: Japanese Paten Laid-open No. 2010-16149

Patent Literature 6: Japanese Paten National Laid-open No. 2007-523249

### SUMMARY OF INVENTION

### Technical Problem

An object of the present invention is to provide a photocurable composition which comprises a specific additive. Said composition has good transferring property of pattern formed on a mold, excellent photocurable property, good detachability from mold (pattern-forming surface) which are improved by adding the specific additive, whereby it is possible to form a pattern with a shape having excellent reproducibility on a substrate. Especially, an object of the present invention is to provide a photocurable imprint composition which can suitably be used for forming a 5 nm to 100 μm pattern, more particularly a 5 nm to 500 nm fine pattern and also to provide a method for forming a pattern using said composition.

### Solution to Problem

The inventors have earnestly studied in order to solve the above problems. As a result, they found that when a hyperbranched polymer is added as the additive to a conventional photocurable imprint composition, a photocurable imprint composition can be obtained which has good transferring property of pattern formed on a mold, excellent photocuring property, good detachability from mold (pattern-forming surface), whereby it is possible to form a pattern with a shape hiving excellent reproducibility on a substrate and completed the present invention. The expression “with excellent reproducibility” means that it is possible to form the dents and dings of pattern corresponding to the dents and dings of pattern of the mold on the coating film formed on the substrate with good precision and in other wards that the identity between the shape of pattern formed on the mold and the shape of pattern which is formed from the coating film after photocuring is excellent.

The present invention relates to a photocurable imprint composition, said composition comprising:

(A) polymerizable monomer having (meth)acrylic group;

(B) photoinitiator; and

(C) hyperbranched polymer prepared by polymerizing polymerizable monomer having (meth)acrylic group. More particularly, the present invention relates to the photocurable imprint composition, said composition comprising 0.1-10 parts by mass of the photoinitiator (B) and 0.1-10 parts by mass of the hyperbranched polymer (C) per 100 parts by mass of the polymerizable monomer (A).

In the present invention, the term “(meth)acrylic group” means methacrylic group or acrylic group.

The polymerizable monomer (A) usable in the photocurable imprint composition according to the present invention comprises preferably mono (meth)acrylates having aromatic ring and/or di(meth)acrylates having aromatic ring and/or polyolefin glycol di(meth)acrylates.

In the present invention, the term “(meth)acrylate” means methacrylate or acrylate.

The present invention relates also to a method for forming a pattern using said photocurable imprint composition, said method comprising steps of:

applying said photocurable imprint composition to a substrate to form a coating film made of said composition;

bringing a pattern-forming surface of a mold on which a desirable pattern is formed into contact with the coating film and irradiating with light as it is to cure said coating film; and

detaching said mold from said cured coating film, whereby a pattern corresponding to the pattern of the pattern-forming surface of said mold is formed on said substrate.

### Advantageous Effects of Invention

Since the photocurable imprint composition according to the present invention is excellent in transferring property of pattern formed on mold and detachability from mold (pattern-forming surface), it is possible to form a pattern with a shape having excellent reproducibility on the substrate. The photocurable imprint composition according to the present invention is suitably used for forming a nano-scale ultrafine pattern and may be used also for forming a pattern having bigger scale-order. The photocurable imprint composition according to the present invention is suitably used in forming a pattern of several micrometer (pm) scale to several nanometer scale, but the use is not limited to formation of the pattern of such size.

### BRIEF DESCRIPTION OF DRAWINGS

FIG. 1 is a photograph by SEM observation, which shows the shape of the transferred pattern formed by the photoimprint method using the photocurable imprint composition of the present invention.

FIG. 2 is a photograph by SEM observation, which shows the shape of the transferred pattern formed by the photoimprint method using the photocurable imprint composition which is prepared without adding the hyperbranched polymer.

### DESCRIPTION OF EMBODIMENTS

Now, the present invention will be explained in detail.

The photocurable imprint composition according to the present invention is characterized in that said composition comprises

(A) polymerizable monomer having (meth)acrylic group;

(B) photoinitiator; and

(C) hyperbranched polymer prepared by polymerizing polymerizable monomer having (meth)acrylic group.

First of all, the polymerizable monomer having (meth)acrylic group (A) will be explained.

Polymerizable Monomer Having (Meth)Acrylic Group (A)

In the present invention, there is no particular limitation on the polymerizable monomer having (meth)acrylic group (A) (hereinafter, it is referred to as “polymerizable monomer (A)”) and the known polymerizable monomers which are usable in photopolymerization can be used. The polymerizable monomer (A) may be monofunctional polymerizable monomer which has one (meth)acrylic group in one molecule or polyfunctional polymerizable monomer which has at least two (meth)acrylic groups in one molecule. Also, these monofunctional polymerizable monomer and polyfunctional polymerizable monomer may be used in combination.

As the example of the polymerizable monomer (A), there can be exemplified as monofunctional polymerizable monomer which has one (meth)acrylic group in one molecule, for example, methyl (meth)acrylate, ethyl (meth)acrylate, propyl (meth)acrylate, n-butyl (meth)acrylate, isobutyl (meth)acrylate, tert-butyl (meth)acrylate, 2-ethylhexyl (meth)acrylate, isodecyl (meth)acrylate, isoamyl (meth)acrylate, isomyristyl (meth)acrylate, n-lauryl (meth)acrylate, n-stearyl (meth)acrylate, isostearyl (meth)acrylate, long-chain alkyl (meth)acrylate, n-butoxyethyl (meth)acrylate, butoxyethylene glycol (meth)acrylate, cyclohexyl (meth)acrylate, tetrahydrofurfuryl (meth)acrylate, butoxyethyl (meth)acrylate, 2-ethylhexyl-diglycol (meth)acrylate, dicyclopentenyl (meth)acrylate, dicyclopentenyloxyethyl (meth)acrylate, dicyclopentanyl (meth)acrylate, benzyl (meth)acrylate, 2-hydroxyethyl (meth)acrylate, 2-hydroxypropyl (meth)acrylate, 2-hydroxybutyl (meth)acrylate, hydroxyethyl (meth)acrylamide, 2-(2-hydroxyethoxy)ethyl (meth)acrylate, glycidyl (meth)acrylate, methoxyethylene glycol modified (meth)acrylate, ethoxyethylene glycol modified (meth)acrylate, propoxyethylene glycol modified (meth)acrylate, methoxypropylene glycol modified (meth)acrylate, ethoxypropylene glycol modified (meth)acrylate, propoxypropylene glycol modified (meth)acrylate, etc. and mono(meth)acrylates having aromatic ring such as phenoxymethyl (meth)acrylate, phenoxyethyl (meth)acrylate, phenoxyethylene glycol modified (meth)acrylate, phenoxypropylene glycol modified (meth)acrylate, hydroxyphenoxyethyl (meth)acrylate, 2-hydroxy-3-phenoxypropyl (meth)acrylate, hydroxyphenoxyethylene glycol modified (meth)acrylate, hydroxyphenoxypropylene glycol modified (meth)acrylate, alkylphenolethylene glycol modified (meth)acrylate, alkylphenolpropylene glycol modified (meth)acrylate, ethoxylated o-phenylphenol (meth)acrylate, isobornyl (meth)acrylate, etc.

Among polyfunctional polymerizable monomers, as bifunctional polymerizable monomer having two (meth)acrylic groups in one molecule, for example, monomers having alkyleneoxide bond in molecule are preferable There can concretely be exemplified ethylene glycol di(meth)acrylate, propylene glycol di(meth)acrylate, polyolefin glycol di(meth)acrylate having a general formula (1): [Formula 1]

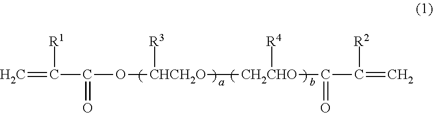

wherein R¹, R², R³ and R⁴ are, independent from each other, hydrogen atom or methyl group; and a and b are an integer of not lower than 0 (zero), respectively; but the mean value of (a+b) is in the range of 2-25.

The polyolefin glycol di(meth)acrylate having the general formula (1) is usually prepared in the form of a mixture of molecules which are different from each other in molecular weight. For this reason, the value of (a+b) is a mean value. In order to enhance the effect of the present invention, the mean value of (a+b) is preferably in the range of 2 to 15, especially the mean value is in the range of 2 to 10.

As other bifunctional polymerizable monomer, there can be exemplified ethoxylated polypropylene glycol di(meth)acrylate, 2-hydroxy-3-acryloyloxypropyl methacrylate, 2-hydroxy-1,3-dimethacryloxypropane, dioxane glycol di(meth)acrylate, tricyclodecanedimethanol di(meth)acrylate, 1,4-butandiol di(meth)acrylate, glycerine di(meth)acrylate, 1,6-hexanediol di(meth)acrylate, 1,9-nonanediol di(meth)acrylate, 1,10-decanediol di(meth)acrylate, neopentylglycol di(meth)acrylate, 2-methyl-1,8-octanediol di(meth)acrylate, 1,9-nonanediol di(meth)acrylate, butylethylpropanediol di(meth)acrylate, 3-methyl-1,5-pentanediol di(meth)acrylate etc. and bifunctional polymerizable monomers having two (meth)acrylic groups (di(meth)acrylate), for example, di(meth)acrylates having aromatic ring such as ethoxylated bisphenol A di(meth)acrylate, propoxylated ethoxylated beisphenol A di(meth)acrylate, ethoxylated bisphenol F di(meth)acrylate, etc.

Among polyfunctional polymerizable monomers, as poly-functional polymerizable monomers having three or more (meth)acrylic groups in one molecule, there can be exemplified ethoxylated glycerine tri(meth)acrylate, trimethylolpropane tri(meth)acrylate, ethoxylated trimethylolpropane tri(meth)acrylate, propoxylated trimethylolpropane tri(meth)acrylate, pentaerythritol tri(meth)acrylate, etc. (trifunctional polymerizable monomer); pentaerythritol tetra(meth)acrylate, di(trimethyrolpropan) tetra(meth)acrylate, ethoxylated pentaerythritol tetra(meth)acrylate, etc. (tetrafunctional polymerizable monomer); di(pentaerythritol) poly(meth)acrylate, etc.

In the present invention, these polymerizable monomers may be used alone or in combination depending on use, shape of pattern to be formed.

Especially, in case that the photocurable imprint composition is a composition designated for the nanoimprint technology, it is preferable to use (meth)acrylate having aromatic ring (wherein the term “(meth)acrylate having aromatic ring” means mono(meth)acrylate having aromatic ring and di(meth)acrylate having aromatic ring) from the point of view of etching resistance and to use polyolefin glycol di(meth)acrylate having the general formula (1) from the point of view of viscosity reduction. Moreover, it is preferable to use a mixture comprising both of (meth)acrylate having aromatic ring and polyolefin glycol di(meth)acrylate because it is possible to prepare a composition for nanoimprint which is excellent in adhesion against substrate, etching resistance, uniformity of coating film, viscosity reduction, etc.

Then, the photoinitiator (B) will be explained.

Photoinitiator (B)

In the present invention, there is no particular limitation on the photoinitiator (B) and any photoinitiator can be used provided that it may photoplymerize the polymerizable monomer (A).

As the photoinitiator, the following compounds can be suitably used: acetophenone derivatives such as 2,2-dimethoxy-1,2-diphenylethan-1-one, 1-hydroxycyclohexyl phenyl ketone, 2-hydroxy-2-methyl-1-phenylpropan-1-one, 1-[4-(2-hydroxyethoxy)-phenyl]-2-hydroxy-2-methyl-1-propan-1-one, 2-hydroxy-1-{4-[4-(2-hydroxy-2-methylpropionyl)-benzyl]-phenyl}-2-methyl-1-propan-1-one, phenylglyoxylic acid methyl ester, 2-methyl-1-[4-(methylthio)phenyl]-2-morpholinoproppan-1-one, 2-benzyl-2-dimethylamino-1-(4-morpholinophenyl)-butanone-1,2-dimethylamino-2-(4-methylbenzyl)-1-(4-morpholin-4-yl-phenyl) butan-1-one, etc.; acylphosphine oxide derivatives such as 2,4,6-trimethylbenzoyldiphosphine oxide, 2,6-dimethoxybenzoyldiphenylphosphine oxide, 2,6-dichlorobenzoyldiphenylphosphine oxide, methyl (2,4,6-trimetylbenzoyl)phenylphosphinate, 2-methylbenzoyldiphenylphosphine oxide, pivaloylphenylphosphinic acid isopropyl ester, bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-propylphenylphosphine oxide, bis-(2,6-dichlorobenzoyl)-1-naphtylphosphine oxide, bis-(2,6-dimethoxybenzoyl)phenylphosphine oxide, bis-(2,6-dimethoxybenzoyl)-2,4,4-trimethylpentylphosphine oxide, bis-(2,6-dimethoxybenzoyl)-2,5-dimethylphenylphosphine oxide, bis-(2,4,6-trimethylbenzoyl)phenylphosphine oxide, bis-(2,5,6-trimethylbenzoyl)-2,4,4-trimethylpentylphosphine oxide, etc.; O-acyloxime derivatives such as 1,2-octadione,1-[4-(phenylthio)phenyl-,2-(O-benzoyloxime)], ethanone,1-[9-ethyl-6-(2-methylbenzoyl)-9H-carbazol-3-yl], 1-(O-acetyloxime), etc.; α-diketones such as diacetyl, acetylbenzoyl, benzyl, 2,3-pentandione, 2,3-octandione, 4,4′-dimethoxybenzyl, 4,4′-dihydroxybenzyl, camphorquinone, 9,10-phenanthrenequinone, acenaphthenequinone, etc.; benzoin alkyl ethers such as benzoin methyl ether, benzoin ethyl ether, benzoin propyl ether, etc.; thioxanthone derivatives such as 2,4-diethoxythioxanthone, 2-chlorothioxanthone, methylthioxanthone, etc.; benzophenone derivatives such as benzophenone, p,p′-bis(dimethylamino)benzophenone, p,p′-dimethoxybenzopehnone, etc.; titanocene derivatives such as bis-(η⁵-2,4-cyclopentadien-1-yl)-bis(2,6-difluoro-3-(1H-pyrol-1-yl)-phenyl)titanium, etc.

These photoinitiators may be used alone or in the form of a mixture of at least two members.

In case of using a-diketone, it is preferably used in combination with tertiary amine compound. As the tertiary amine compound usable in combination with a-diketone, there can be exemplified N,N-dimethylaniline, N,N-diethylaniline, N,N-di(n-butyl)aniline, N,N-dibenzylaniline, N,N-dimethyl-p-toluidine, N,N-diethyl-p-toluidine, N,N,-dimethyl-m-toluidine, p-bromo-N,N-dimethylaniline, m-chloro-N,N-dimethylaniline, p-dimethylaminobenzaldehyde, p-dimethylaminoacetophenone, p-dimethylaminobenzoic acid, p-dimethylaminobenzoic acid ethyl ester, p-dimethylaminobenzoic acid amyl ester, N,N-dimetylanthranilic acid methyl ester, N,N-dihydroxyethylaniline, N,N-dihydroxyethyl-p-toluidine, p-dimethylaminophenetyl alcohol, p-dimethylaminostilbene, N,N-dimethyl-3,5-xylidine, 4-dimethylaminopylidine, N,N-dimetyl-α-naphthylamine, N,N-dimetyl-β-naphthylamine, tributylamine, tripropylamine, triethylamine, N-methyldiethanolamine, N-ethyldiethanolamine, N,N-dimethylhexylamine, N,N-dimethyldodecylamine, N,N-dimethylstearylamine, N,N-dimethylaminoethyl methacrylate, N,N-diethylaminoethyl methacrylate, 2,2′-(n-butylimino)diethanol, etc.

In case that the photocurable imprint composition is a composition designated for the nanoimprint technology, it is preferable to use acetophenone derivatives, acylphosphine oxide derivatives, O-acyloxime derivatives, α-diketones.

Then, the hyperbranched polymer (C) which is obtained by polymerizing polymerizable monomer having (meth)acrylic group will be explained.

Hyperbranched Polymer Prepared by Polymerizing Polymerizable Monomer Having (Meth)Acrylic Group (C)

In the present invention, the hyperbranched polymer which is an additive is hyperbranched polymer which is obtained by polymerizing polymeirizable monomer having (meth)acrylic group. Hereinafter, there is a case that the hyperbranched polymer which is obtained by polymerizing polymeirizable monomer having (meth)acrylic group (C) is referred to merely as “hyperbranched polymer (C)”.

In the present invention, the hyperbranched polymer (C) must be a polymer which is obtained by polymerizing polymeirizable monomer having (meth)acrylic group. By using the polymeirizable monomer having (meth)acrylic group, solubility of the hyperbranched polymer (C) into the polymerizable monomer (A) is enhanced, whereby it is possible to form a good cured product while the dispersion of the hyperbranched polymer in the formed curing product is enhanced. Thus, the obtained composition can provide excellent effect.

Though a reason why the photocurable imprint composition of the present invention can provide excellent pattern-transferring property, detachability from mold by blending the hyperbranched polymer (C) is unknown, it is believed that it is caused by a fact that the hyperbranched polymer is spherical in molecular size. It is considered that since the hyperbranched polymer is spherical, the fluidity, curing property of the photocurable imprint composition is not disturbed by the hyperbranched polymer (C) and accordingly a pattern with shape having excellent reproducibility can be transferred. In addition to these effects, it is considered that the spherical hyperbranched polymer improves the detachability between cured product and mold, electrostatic interaction. Consequently, it is believed that the photocurable imprint composition of the present invention which comprises the hyperbranched polymer (C) can form a nano-scale pattern made of curing product with the shape having excellent reproducibility without causing adhesion between patterns in comparison with a composition comprising no hyperbranched polymer. Since the photocurable imprint composition of the present invention provides the above-mentioned effects, it is suitably usable for, in especial, the nanoimprint technology by which an ultrafine pattern can be formed.

The diameter of hyperbranched polymer (C) is preferably in the range of 1 to 10 nm. Though, as mentioned above, the hyperbranched polymer (C) is spherical, if the diameter is in the above-said range, it can suitably be used for the noanoimprint technology. Especially, in order to form a pattern having up to 20 nm of line width, the diameter of the hyperbranched polymer is preferably in the range of 1 to 5 nm.

In the present invention, there is no particular limitation on molecular weight of the hyperbtanch polymer (C) but the range of 10,000 to 100,000 is preferable, taking the solubility in the polymerizable monomer (A), the spherical size, the effect obtaining when the hyperbranched polymer (C) is contained in the curing product, into consideration.

The hyperbranched polymer (C) can be synthesized according to the known method. As the method for preparation of hyperbranched polymer, the method disclosed in, for, example, Japanese Patent Laid-open No. 2000-347412, Japanese Patent Laid-open No. 2009-155619, Japanese Patent Laid-open No. 2010-24330, Macromol. Chem. Phys. 2005, 206, 860-868, Polym Int 53: 1503-1511, (2004), WO 2006/093050, WO 2007/148578, WO 2008/029806, WO 2008/102680, WO 2009/035042, WO 2009/054455 can be used. Among hyperbranched polymers, the pyperbranch polymer which is obtained by polymerizing ethylene glycol di(meth)acrylate, diethylene glycol di(meth)acrylate, propylene glycol di(meth)acrylate, or dipropylene glycol di(meth)acrylate is preferable and especially it is preferable to use the polymer having the bonding moiety which is represented by a general formula (2) described below. It is preferable that terminal structure of the hyperbranched polymer is alkyl ester group having comparatively low polarity.

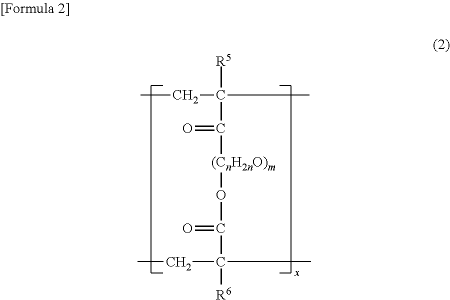

wherein, R⁵ and R⁶ are, independent from each other, hydrogen atom, or linear, branched or cyclic C1-20 alkyl group of C1-20 alkyl ester group and R⁵ and R⁶ may be the same as or different from each other; n and m are, independent from each other, an integer of not lower than 1; x is 10 to 1,000.

In the hyperbranched polymers having the bonding moiety which is represented by the general formula (2), it is preferable that R⁵ and R⁶ are hydrogen atom or methyl group; n is 1 to 3; and m is 1 to 10.

The hyperbranched polymers are commercially available and for example, HYPERTECH® (NISSAN CHEMICAL INDUSTRIES, Ltd.) can be used.

Then, the blending ratio of the polymerizable monomer (A), the photoinitiator (B) and the hyperbranched polymer (C) will be explained.

According to an embodiment of the present invention, the photocurable imprint composition is characterized in that said composition comprises 0.1-10 parts by mass of the hyperbranched polymer (C) per 100 parts by mass of the polymerizable monomer (A).

Blending Amount of Respective Ingredients

The photocurable imprint composition of the present invention comprises preferably the hyperbranched polymer (C) in the amount of 0.1-10 parts by mass per 100 parts by mass of the polymerizable monomer (A). In case that the compounding amount of the hyperbranched polymer (C) is less than 0.1 parts by mass, the transferring property of pattern which is formed on mold to the coating film, especially the transferring property of fine pattern having the size of 500 nm or less is deteriorated and the tendency becomes remarkable in an ultrafine pattern having the size of 100 nm of less. On the other hand, in case of the amount exceeding 10 parts by mass, the appearance of the coating film has a tendency to deteriorate. Taking the transferring property, the appearance of obtaining coating film into consideration, the compounding amount of the hyperbranched polymer (C) is preferably in the range of 0.1-5 parts by mass, more preferably 0.5-3 parts by mass.

Also, the photocurable imprint composition of the present invention comprises preferably the photoinitiator (B) in the amount of 0.1-10 parts by mass per 100 parts by mass of the polymerizable monomer (A). In case that the compounding amount of the phtoinitiator (B) is less than 0.1 parts by mass, the curing is likely to be insufficient in a surface or an interior region of the coating film which is formed by photopolymerization and it takes long time for photopolymerization and accordingly the productivity is apt to lower. On the other hand, in case of the amount exceeding 10 parts by mass, the appearance of the coating film is likely to be poor and the smoothness of surface is apt to deteriorate. Taking the photocurable property, the photo-polymerization rate, the appearance of the coating film into consideration, the compounding amount of the photoinitiator (B) is preferably in the range of 0.5-5 parts by mass, more preferably 1-5 parts by mass.

Other Additives

The photocurable imprint composition of the present invention may comprise other known additives besides the hyperbranched polymer (C) as far as the effects of the present invention are not affected. Particularly, the additive such as surfactant, polymerization inhibitor, reactive diluent, silane coupling agent, organic solvent for dilution may be added. For a purpose of uniformity of coating film a surfactant may be added and a polymerization inhibitor may be added in order to stabilize so that the polymerization is not caused during preservation.

In case of using surfactant, it may be compounded at the ratio of 0.0001-0.1 parts by mass, preferably 0.0005-0.01 parts by mass per 100 parts by mass of the polymerizable monomer (A).

As surfactant, fluorine-containing surfactant, silicone based surfactant, aliphatic surfactant may be used. Especially, aliphatic surfactant is preferably used, because when the composition is applied to a substrate such as silicon wafer, “repelling” is not caused and the composition can be uniformly applied to the substrate. As example of surfactant, there can be exemplified anionic surfactants such as metal salts of higher fatty alcohol sulfate such as sodium decyl sulfate, sodium lauryl sulfate, etc., metal salts of aliphatic carboxylic acid such as sodium laurate, sodium stearate, sodium oleate, etc., metal salts of higher alkyl ether sulfate such as sodium lauryl ether sulfate (prepared by sulfating adduct of lauryl alcohol and ethylene oxide), etc., sulfosuccinic acid diesters such as sodium sulfosuccinate, etc., salts of fatty alcohol ethylene oxide adduct sulfate, etc.; cationic surfactants such as alkyl amine salts such as dodecylammonium chloride, etc, quarternary ammonium salts such as trimethyldodecylammonium bromide, etc.; amphoteric surfactants such as alkyldimethylamine oxides such as dodecyldimethylamine oxide, etc., alkylcarboxybetaines such as dodecylcarboxybetaine, etc., alkylsulfobetaines such as dodecylsulfobetaine, etc., amidoamino acid salts such as lauramidopropylamine oxide, etc.; nonionic surfactants such as polyoxyethylene alkyl ethers such as polyoxyethylene lauryl ether, etc., polyoxyalkylene alkyl ethers, polyoxyethylene alkylpehnyl ethers such as polyoxyethylene distyrenated phenyl ethers, polyoxyethylene laurylphenyl ether, etc., polyoxyethylene tribenzylpehnyl ethers, fatty acid polyoxyethylene esters such as fatty acid polyoxyethylene laurate, polyoxyethylenesorbitan esters such as polyoxyethylenesorbitan laurate, etc. The respective surfactants may be used alone and if necessary, they may be used in combination of a plurality of types.

In case of using polymerization inhibitor, it may be compounded at the ratio of 0.01-1.0 parts by mass, preferably 0.1-0.5 parts by mass per 100 parts by mass of the polymerizable monomer (A).

As polymerization inhibitor, there can be exemplified the known compounds and as the most representative polymerization inhibitor, there can be exemplified hydroquinone monomethyl ether, hydroquinone, butylhydroxytoluene, etc.

As reactive diluent, there can be exemplified known compounds such as N-vinylpyrrolidone, acryloylmorpholine, etc.

There is no particular limitation on amount of reactive diluent. The amount of reactive diluent is suitably selected from the range wherein the formation of pattern using mold is not affected and can suitably be selected from the range of 1-50 parts by mass per 100 parts by mass of polymerizable monomer (A). Particularly, taking viscosity reduction of photocurable imprint composition, mechanical strength of pattern into consideration, the amount of the reactive diluent is preferably in the range of 5-30 parts by mass.

As silane coupling agent, there can be exemplified known compounds such as alkyltrimethoxysilane, alkyltriethoxysilane, vinyltrimethoxysilane, vinyltriethoxysilane, diethoxymethoxyvinylsilane, vinyltris(2-methoxyethoxy)silane, vinylmethyldimethoxysilane, 3-methacryloxypropyltrimethoxysilane, 3-methacryloxypropyltriethoxysilane, 3-methacryloxypropylmethyldimethoxysilane, 3-methacryloxypropylmethyldiethoxysilane, 3-acryloxypropyltrimethoxysilane, 3-acryloxypropyltriethoxysilane, 3-acryloxypropylmethyldimethoxysilane, 3-acryloxypropylmethyldiethoxysilane, glycidoxymethyltrimethoxysilane, 2-glycidoxyethyltrimethoxysilane, 3-glycidoxypropyltrimethoxysilane, 3-glycidoxypropylmethyldiethoxysilane, 3-glycidoxypropyltriethoxysilane, 3-glycidoxypropyltributoxysilane, (3,4-ephoxycyclohexyl)methyltrimethoxysilane, (3,4-ephoxycyclohexyl)methyltripropoxysilane, 2-(3,4-ephoxycyclohexyl)ethyltrimethoxysilane, 3-(3,4-ephoxycyclohexyl)propyltrimethoxysilane, aminomethyltriethoxysilane, 2-aminoethyltrimethoxysilane, 1-aminoethyltrimethoxysilane, 3-aminopropyltrimethoxysilane, 3-aminopropyltriethoxysilane, N-aminomethylaminomethyltrimethoxysilane, N-aminomethyl-3-aminopropyltrimethoxysilane, N-(2-aminoethyl)-3-aminopropylmethyldimethoxysilane, vinyltrimethoxysilane, vinyltriacetoxysilane, N-β-(N-vinylbenzylaminoethyl)-γ-aminopropyltrimethoxysilane, etc.

In case of using silane coupling agent, there is no particular limitation on amount of silane coupling agent. The amount of silane coupling agent is suitably selected within the range wherein the formation of pattern using mold is not affected and can suitably be selected form the range of 0.1-10 parts by mass per 100 parts by mass of polymerizable monomer (A). Particularly, taking effects such as adhesion against mold, etc. into consideration, the amount of the silane coupling agent is preferably in the range of 0.5-5 parts by mass.

The photocurable imprint composition of the present invention is used by applying the composition onto a substrate. On using, the photocurable imprint composition may be dilueted by an organic solvent. There is no particular limitation on the organic solvent usable for diluting and any organic solvent may be used provided that it can solve the photocurable imprint composition of the present invention. There can be exemplified acetonitrile, tetrahydrofuran, toluene, chloroform, ethyl acetate, methyl ethyl ketone, dimethylformamide, cyclohexanone, propylene glycol methyl ether, propylene glycol monomethyl ether acetate, methyl-3-methoxypropionate, ethylene glycol monoethyl ether acetate, ethyl lactate, ethyl-3-ethoxypropionate, butyl acetate, 2-heptanone, methyl isobutyl ketone, etc.

In case of using organic solvent, there is no particular limitation on amount of organic solvent and the amount is suitably selected depending on thickness of coating film to be formed. Particularly, the amount of the organic solvent is selected within such range that the concentration of the photocurable imprint composition is in the range of 1-90% by mass, assuming that the total amount of the organic solvent and the photocurable imprint composition is 100.

Preparation of Photocurable Imprint Composition

The photocurable imprint composition of the present invention can be prepared by mixing the polymeilizable monomer (A), the photoinitiator (B), the hyperbranched polymer (C), and other additive which may be added in accordance with necessary. There is no particular limitation on order of addition of these ingredients.

The photocurable imprint composition of the present invention can be prepared by the above-mentioned method. Then, a method for forming a pattern on a substrate using the photocurable imprint composition will be explained.

Method for Forming Pattern on Substrate

The method for forming a pattern on a substrate using the photocurable imprint composition of the present invention is explained.

First of all, a coating film is prepared by applying the photocurable imprint composition which is prepared by the above-mentioned method on a known substrate, sheet or film such as silicon wafer, quartz, glass, sapphire, various metal materials, ceramics such as alumina, aluminum nitride, silicon carbide, silicon nitride, etc, polyethylene terephthalate film, polypropylene film, polycarbonate film, triacetylcellulose film, cycloolefin resin film, by a known method such as spin coating, dipping, dispensing, ink-jet, roll-to-roll. There is no particular limitation on thickness of the coating film. The thickness can suitably be determined in accordance with the intended use, but it is usually within the range of 0.1-5 μm. Also, the photocurable imprint composition of the present invention can suitably be used in a formation of a coating film having the thickness of 0.01-0.1 μm.

In order to forma thin coating film, it is possible to dilute the photocurable imprint composition with an organic solvent. In this case, a drying step may suitable be incorporated in accordance with boiling point, volatility of the organic solvent to be used to form a patter.

Then, a pattern-forming surface of a mold on which a desirable pattern is previously formed is brought into contact with the formed coating film. The mold is preferably made of transparent material such as quartz, transparent resin film in order to cure the applied composition via light-irradiation to form the coating film. Thereafter, as remaining the situation of contacting the pattern-forming surface of mold with the coating film, alight is irradiated to cure the coating film. The light to be irradiated has the wave-length of up to 500 nm and the irradiation time is selected from the range of 0.1-300 seconds. It is usually within the range of 1-60 seconds but it may vary depending to the thickness of coating film.

With respect to an atmosphere in which the photo-polymerization is carried out, the photopolymerization may be carried out in the atmosphere but it is preferable to conduct the photopolymerization in an atmosphere in which disturbance due to oxygen is lowered such as nitrogen gas atmosphere, inert gas atmosphere, fluorine gas atmosphere, vacuum atmosphere, etc.

After the photopolymerization, a laminate in which a pattern is formed by the cured coating film on the substrate is obtained by detaching the mold from the cured coating film. The photocurable imprint composition of the present invention provides good detachability from mold especially in a case of forming a fine pattern having the line width of 5 nm-100 μm. Among the patterns having the line width within the above-mentioned range, the photocurable imprint composition of the present invention provides good detachability from mold especially in a case of forming a fine pattern having the line width of 5 nm-500 nm and also in a case of forming an ultrafine pattern having the line width of 5 nm-100 nm.

Then, the uncured coating film of the photocurable imprint composition which is present between the mold and the formed pattern layer is removed by a technique such as oxygen reactive ion etching method, etc. to expose a surface of the substrate. Thereafter, using the formed pattern layer as a mask, etching is carried out or a metal is deposited, the layer formed from the photocurable imprint composition is removed in order to utilize as a wiring.

### EXAMPLE

Now, the present invention will be described in more detail by way of examples and comparative examples, but the present invention is not limited to these examples.

First, the method for measuring shape (measurement of diameter), molecular weight of the hyperbranched polymer to be used will be explained.

Identification of Diameter of Hyperbranched Polymer (Spherical Particle)

The hyperbranched polymer is observed with transmission electron microscope (TEM). The particle size (diameter) is measured and the mean of measured values is assumed as a mean particle size (mean value of diameter).

The diameter of hyperbranched polymer may be identified before blending the hyperbranched polymer with the photocurable imprint composition, or the diameter may be identified by observing the photocurable imprint composition with which the hyperbranched polymer has been blended. Incase that the identification is conducted by observing the photocurable imprint composition to which the hyperbranched polymer has been compounded, the diameter may be identified after the hyperbranched polymer only is precipitated with organic solvent.

Measurement of Molecular Weight of Hyperbranched Polymer (Spherical Molecule)

The absolute molecular weight (Mw) is calculated by GPC-MALS method using tetrahydrofuran as solvent.

Evaluation of Transferring Property

The shape-transferring property of the pattern which is formed on the substrate by using the photocurable imprint composition is evaluated by observation with scanning electron microscope (SEM).

The evaluation is conducted on the transferred pattern of 80 nm line/space (1:1) shape with total 15 lines. Evaluation standards are shown below.

∘: Pattern shape is completely transferred.

Δ: Some defects of pattern shape are visible.

x: Pattern shape is not at all transferred.

### Example 1

As the polymerizable monomer having (meth)acrylic group (A), 40 parts by mass of polyoethylene glycol di(meth)acrylate having the above-said general formula (1) wherein R¹ and R² are methyl group, R³ and R⁴ are hydrogen atom, and the mean value of (a+b) is 4 (NK Ester A-200; Shin-Nakamura Chemical Co., Ltd.) and 60 parts by mass of ethoxylated bisphenol A diacrylate (NK Ester A-BPE-10; Shin-Nakamura Chemical Co., Ltd.) were used.

As the photoinitiator (B), 2.5 parts by mass of 2,2-dimethoxy-1,2-diphenylethan-1-one (IRGACURE® 651; BASF Japan Ltd.) and 2.5 parts by mass of bis (2,4,6-trimethylbenzoyl)-phenylphosphine oxide (IRGACURE® 819; BASF Japan Ltd.) were used.

As the hyperbranched polymer (C), 1.0 parts by mass of a commercially available hyperbranched polymer (HYPERTECH® HA-DMA-200; NISSAN CHEMICAL INDUSTRIES Ltd.) was used, said hyperburanch polymer having a branch-forming main chain of methacrylic skeleton which is obtained by polymerizing ethylene glycol methacrylate and a molecular terminal of methyl ester.

As the polymerization inhibitor, 0.15 parts by mass of hydroquinone monomethyl ether and 0.02 parts by mass of butylhydroxytoluene were used.

The photocurable imprint composition was prepared by mixing above-mentioned ingredients. The absolute molecular weight (Mw) of the used hyperbranched polymer HA-DMA-200 was 50,000 and the mean particle size was 5 nm.

Application of Photocurable Imprint Composition

The prepared photocurable imprint composition was diluted with methyl 3-methoxypropionate ester to adjust the solid concentration to be 20% by mass. The diluted photocurable imprint composition was applied on a silicon wafer (P-type, one mirror-finished surface, no oxidized membrane) by spin-coating method at 3000 rpm for 30 seconds and then dried at 110° C. for 1 minute. Thus, the silicon wafer on which the coating film of the photocurable imprint composition having the thickness of 300 nm was formed was obtained.

Formation of Pattern and Evaluation

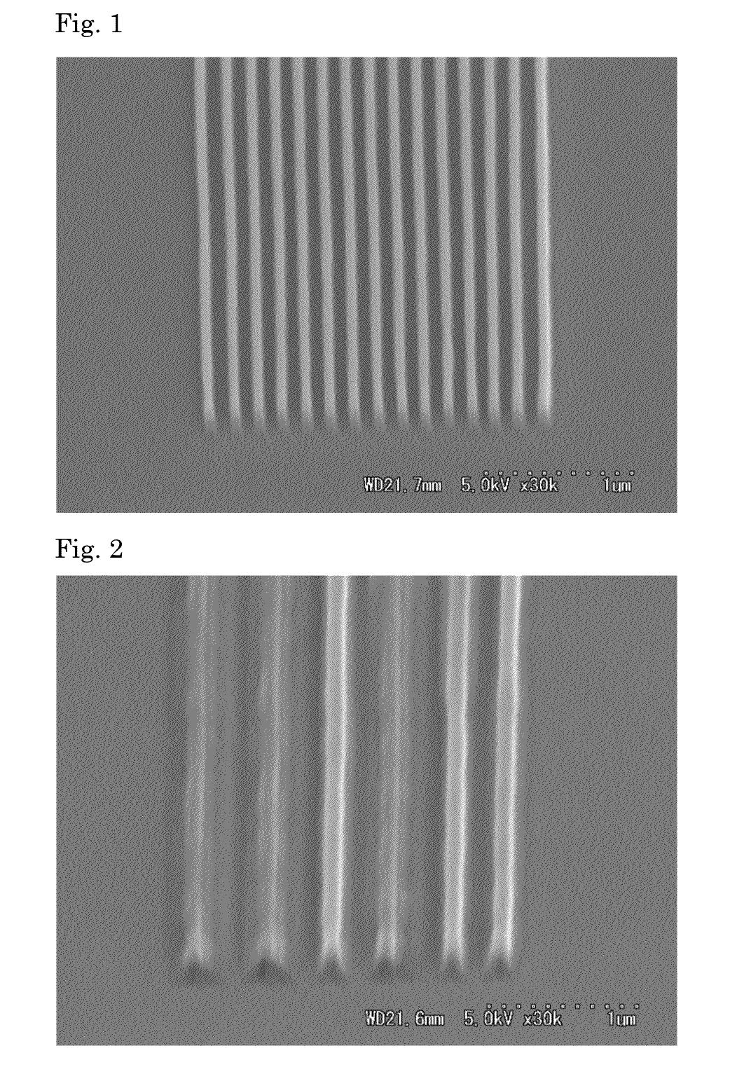

Using a quartz mold with minimum pattern of 80 nm (80L RESO; NTT-AT Nanofabrication Ltd.), the obtained silicon wafer with the coating film having the thickness of 300 nm was subjected to a light nanoimprint by irradiating with light from a LED light source of 365 nm for 200 seconds in a nanoimprinting apparatus (ImpFlex Essential; SANMEI ELECTRONICS Co., Ltd.). The shape of pattern transferred after the light imprint was observed by SEM. The obtained photograph was shown in FIG. 1. It can be seen from FIG. 1 that the pattern having the line width of 80 nm was favorably transferred.

### Example 2

The photocurable imprint composition was prepared in the same manner as in Example 1 but using 3 parts by mass of a commercially available hyperbranched polymer (HYPERTECH® HA-DMA-50; mean molecular weight (Mw): 20000; NISSAN CHEMICAL INDUSTRIES Ltd.) as the hyperbranched polymer, said hyperburanch polymer having the branch-forming main chain forming branch of methacrylic skeleton and the molecular terminal of methyl ester. The light imprint of substrate and the evaluation of formed pattern were conducted in the same manner as in the Example 1 (application of photocurable imprint composition, formation of pattern). The mean particle size of the used hyperbranched polymer HA-DMA-50 was 2 nm.

The shape of pattern transferred after the light imprint was observed by SEM. As a result, similarly to the pattern shown in FIG. 1, the pattern of 80 nm was completely transferred.

### Example 3

The photocurable imprint composition was prepared in the same manner as in Example 1 but using 0.5 parts by weight of a commercially available hyperbranched polymer (HYPERTECH® HA-DMA-50; mean molecular weight (Mw): 20000; NISSAN CHEMICAL INDUSTRIES Ltd.) as the hyperbranched polymer, said hyperburanch polymer having the branch-forming main chain of methacrylic skeleton and the molecular terminal of methyl ester. The light imprint of substrate and the evaluation of formed pattern were conducted in the same manner as in the Example 1 (application of photocurable imprint composition, formation of pattern).

The shape of pattern transferred after the light imprint was observed by SEM. As a result, similarly to the pattern shown in FIG. 1, the pattern of 80 nm was completely transferred.

### Example 4

The photocurable imprint composition was prepared in the same manner as in Example 1 but using 40 parts by mass of polyethylene glycol diacrylate (NK Ester A-200; Shin-Nakamura Chemical Co., Ltd.) and 60 parts by mass of ethoxylated bisphenol A dimethacrylate (NK Ester BPE-200; Shin-Nakamura Chemical Co., Ltd.) as the polymeizable monomer having (meth)acrylic group. The light imprint of substrate and the evaluation of formed pattern were conducted in the same manner as in the Example 1 (application of photocurable imprint composition, formation of pattern).

The shape of pattern transferred after the light imprint was observed by SEM. As a result, similarly to the pattern shown in FIG. 1, the pattern of 80 nm was completely transferred.

### Example 5

The photocurable imprint composition was prepared in the same manner as in Example 1 but using 1.0 parts by mass of 2-dimethylamino-2-(4-methyl-benzyl)-1-(4-molpholin-4-yl-ph enyl)-butan-1-one (IRGACURE® 379 EG; BASF Japan Ltd.) as the photoinitiator. The light imprint of substrate and the evaluation of formed pattern were conducted in the same manner as in the Example 1 (application of photocurable imprint composition, formation of pattern).

The shape of pattern transferred after the light imprint was observed by SEM. As a result, similarly to the pattern shown in FIG. 1, the pattern of 80 nm was completely transferred.

### Example 6

The photocurable imprint composition was prepared in the same manner as in Example 1 but using 40 parts by mass of phenoxyethylene glycol modified acrylate (NK Ester AMP-10G; Shin-Nakamura Chemical Co., Ltd.) and 60 parts by mass of ethoxylated bisphenol A diacrylate (NK Ester A-BPE-10; Shin-Nakamura Chemical Co., Ltd.) as the polymeizable monomer having (meth)acrylic group. The light imprint of substrate and the evaluation of formed pattern were conducted in the same manner as in the Example 1 (application of photocurable imprint composition, formation of pattern).

The shape of pattern transferred after the light imprint was observed by SEM. As a result, similarly to the pattern shown in FIG. 1, the pattern of 80 nm was completely transferred.

### Example 7

The photocurable imprint composition was prepared in the same manner as in Example 1 but using 40 parts by mass of phenoxyethylene glycol modified acrylate (NK Ester AMP-10G; Shin-Nakamura Chemical Co., Ltd.) and 60 parts by mass of tricyclodecanedimethanol diacrylate (NK Ester A-DCP; Shin-Nakamura Chemical Co., Ltd.) as the polymeizable monomer having (meth)acrylic group. The light imprint of substrate and the evaluation of formed pattern were conducted in the same manner as in the Example 1 (application of photocurable imprint composition, formation of pattern).

The shape of pattern transferred after the light imprint was observed by SEM. As a result, similarly to the pattern shown in FIG. 1, the pattern of 80 nm was completely transferred.

### Example 8

The photocurable imprint composition was prepared in the same manner as in Example 1 but using 40 parts by mass of 2-(2-vinyloxyethoxy)ethyl acrylate (VEEA; NIPPON SHOKUBAI) and 60 parts by mass of ethoxylated bisphenol A diacrylate (NK Ester A-BPE-10; Shin-Nakamura Chemical Co., Ltd.) as the polymeizable monomer having (meth)acrylic group. The light imprint of substrate and the evaluation of formed pattern were conducted in the same manner as in the Example 1 (application of photocurable imprint composition, formation of pattern). The shape of pattern transferred after the light imprint was observed by SEM. As a result, similarly to the pattern shown in FIG. 1, the pattern of 80 nm was completely transferred.

### Example 9

The photocurable imprint composition was prepared in the same manner as in Example 1 but using 40 parts by mass of 2-(2-vinyloxyethoxy)ethyl acrylate (VEEA; NIPPON SHOKUBAI), 40 parts by mass of tricyclodecanedimethanol diacrylate (NK Ester A-DCP; Shin-Nakamura Chemical Co., Ltd.) and 20 parts by mass of polyethylene glycol diacrylate (NK Ester A-200; Shin-Nakamura Chemical Co., Ltd.) as the polymeizable monomer having (meth)acrylic group. The light imprint of substrate and the evaluation of formed pattern were conducted in the same manner as in the Example 1 (application of the photocurable imprint composition, formation of pattern).

The shape of pattern transferred after the light imprint was observed by SEM. As a result, similarly to the pattern shown in FIG. 1, the pattern of 80 nm was completely transferred.

### Comparative Example 1

The light imprint of substrate was conducted in the same manner as in the Example 1 but the hyperbranched polymer was not compounded.

The shape of pattern transferred after the light imprint was observed by SEM. The obtained photograph was shown in FIG. 2. It can be seen From FIG. 2 that the lines each of which has the line width of 80 nm were adhered to each other and the pattern was not completely transferred.

### Comparative Example 2

The photocurable imprint composition was prepared in the same manner as in Example 1 but using 0.5 parts by mass of hyperbranched polymer (HYPERTECH® HA-DVB-500; NISSAN CHEMICAL INDUSTRIES Ltd.) as the hyperbranched polymer, said hyperbranched polymer having the branch-forming main chain of styrene skeleton and the molecular terminal of methyl ester. Since the hyperbranched polymer HA-DVB-500 was not dispersed into the polymerizable monomer having (meth)acrylic group, the test was discontinued.

### Comparative Example 3

The photocurable imprint composition was prepared in the same manner as in Example 1 but using 0.5 parts by mass of hyperbranched polymer (HYPERTECH® HPS-200; NISSAN CHEMICAL INDUSTRIES Ltd.) as the hyperbranched polymer, said hyperbranched polymer having the branch-forming main chain of styrene skeleton and the molecular terminal of dimethyl carbonate. Since the hyperbranched polymer HPS-200 was not dispersed into the polymerizable monomer having (meth)acrylic group, the test was discontinued.

The results of the Examples 1-9 and the Comparative examples 1-3 were summarized in the following table.

TABLE 1

| | Evaluation of patter-transferring |
|---|---|
| Example | property |
| Ex. 1 | ◯ |
| Ex. 2 | ◯ |
| Ex. 3 | ◯ |
| Ex. 4 | ◯ |
| Ex. 5 | ◯ |
| Ex. 6 | ◯ |
| Ex. 7 | ◯ |
| Ex. 8 | ◯ |
| Ex. 9 | ◯ |
| Comparative | X |
| Ex. 1 | |
| Comparative | — |
| Ex. 2 | |
| Comparative | — |
| Ex. 3 | |

1. A photocurable composition for imprint, said composition comprising:
(A) polymerizable monomer having (meth)acrylic group;
(B) photoinitiator; and
(C) hyperbranched polymer prepared by polymerizing polymerizable monomer having (meth)acrylic group.

2. The photocurable composition for imprint according to the claim 1, wherein said composition comprises 0.1-10 parts by mass of the hyperbranched polymer (C) per 100 parts by mass of the polymerizable monomer (A).

3. The photocurable composition for imprint according to the claim 1, wherein said composition comprises 0.1-10 parts by mass of photoinitiator (B) and 0.1-10 parts by mass of the hyperbranched polymer (C) per 100 parts by mass of the polymerizable monomer (A).

4. The photocurable composition for imprint according to claim 1, wherein said polymerizable monomer (A) comprises (meth)acrylate having aromatic ring and/or polyolefin glycol di(meth)acrylate having a general formula (1): 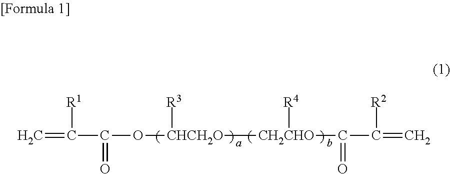
wherein R¹, R², R³ and R⁴ are, independent from each other, hydrogen atom or methyl group; and a and b are an integer of not lower than 0 (zero), respectively; but the mean value of (a+b) is in the range of 2-25.

5. The photocurable composition for imprint according to the claim 4, wherein said (meth)acrylate having aromatic ring is mono(meth)acrylate having aromatic ring and/or di(meth)acrylate having aromatic ring.

6. The photocurable composition for imprint according to the claim 5, wherein said mono(meth)acrylate having aromatic ring is selected from a group consisting of phenoxymethyl (meth)acrylate, phenoxyethyl (meth)acrylate, phenoxyethylene glycol modified (meth)acrylate, phenoxypropylene glycol modified (meth)acrylate, hydroxypehnoxyethyl (meth)acrylate, 2-hydroxy-3-pehnoxypropyl (meth)acrylate, hydroxyphenoxyethylene glycol modified (meth)acrylate, hydroxyphenoxypropylene glycol modified (meth)acrylate, alkylphenolethylene glycol modified (meth)acrylate, alkylphenolpropylene glycol modified (meth)acrylate, ethoxylated o-phenylphenol (meth)acrylate, and isobornyl (meth)acrylate; and di(meth)acrylate having aromatic ring is selected form a group consisting of ethoxylated bisphenol A di(meth)acrylate, propoxylated ethoxylated bisphenol A di(meth)acrylate, and ethoxylated bisphenol F di(meth)acrylate.

7. The photocurable composition for imprint according to claim 1, wherein said composition is used in formation of a pattern of 5 nm-100 μm.

8. The photocurable composition for imprint according to the claim 7, wherein said composition is used in formation of a fine pattern of 5 nm-500 nm.

9. A method for forming a pattern, comprising steps of:
applying the photocurable composition for imprint according to claim 1 to a substrate to form a coating film made of said composition;
bringing a pattern-forming surface of a mold on which a desirable pattern is formed into contact with said coating film and irradiating with a light as it is to cure said coating film; and
detaching said mold from said cured coating film, whereby a pattern corresponding to the pattern of said pattern-forming surface of said mold is formed on said substrate.

10. The photocurable composition for imprint according to the claim 2, wherein said composition comprises 0.1-10 parts by mass of photoinitiator (B) and 0.1-10 parts by mass of the hyperbranched polymer (C) per 100 parts by mass of the polymerizable monomer (A).

11. The photocurable composition for imprint according to claim 2, wherein said polymerizable monomer (A) comprises (meth)acrylate having aromatic ring and/or polyolefin glycol di(meth)acrylate having a general formula (1): 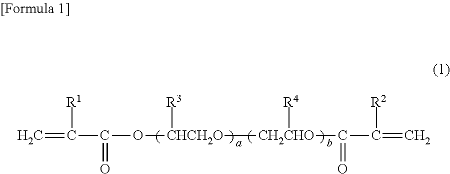
wherein R¹, R², R³ and R⁴ are, independent from each other, hydrogen atom or methyl group; and a and b are an integer of not lower than 0 (zero), respectively; but the mean value of (a+b) is in the range of 2-25.

12. The photocurable composition for imprint according to claim 3, wherein said polymerizable monomer (A) comprises (meth)acrylate having aromatic ring and/or polyolefin glycol di(meth)acrylate having a general formula (1): 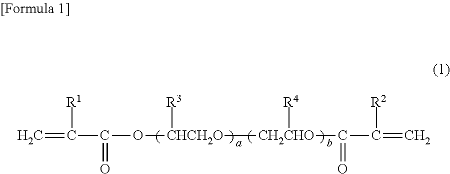
wherein R¹, R², R³ and R⁴ are, independent from each other, hydrogen atom or methyl group; and a and b are an integer of not lower than 0 (zero), respectively; but the mean value of (a+b) is in the range of 2-25.

13. The photocurable composition for imprint according to claim 2, wherein said composition is used in formation of a pattern of 5 nm-100 μm.

14. The photocurable composition for imprint according to claim 3, wherein said composition is used in formation of a pattern of 5 nm-100 μm.

15. The photocurable composition for imprint according to claim 4, wherein said composition is used in formation of a pattern of 5 nm-100 μm.

16. The photocurable composition for imprint according to claim 5, wherein said composition is used in formation of a pattern of 5 nm-100 μm.

17. The photocurable composition for imprint according to claim 6, wherein said composition is used in formation of a pattern of 5 nm-100 μm.

18. A method for forming a pattern, comprising steps of:
applying the photocurable composition for imprint according to claim 2 to a substrate to form a coating film made of said composition;
bringing a pattern-forming surface of a mold on which a desirable pattern is formed into contact with said coating film and irradiating with a light as it is to cure said coating film; and
detaching said mold from said cured coating film, whereby a pattern corresponding to the pattern of said pattern-forming surface of said mold is formed on said substrate.

19. A method for forming a pattern, comprising steps of:
applying the photocurable composition for imprint according to claim 3 to a substrate to form a coating film made of said composition;
bringing a pattern-forming surface of a mold on which a desirable pattern is formed into contact with said coating film and irradiating with a light as it is to cure said coating film; and
detaching said mold from said cured coating film, whereby a pattern corresponding to the pattern of said pattern-forming surface of said mold is formed on said substrate.

20. A method for forming a pattern, comprising steps of:
applying the photocurable composition for imprint according to claim 4 to a substrate to form a coating film made of said composition;
bringing a pattern-forming surface of a mold on which a desirable pattern is formed into contact with said coating film and irradiating with a light as it is to cure said coating film; and
detaching said mold from said cured coating film, whereby a pattern corresponding to the pattern of said pattern-forming surface of said mold is formed on said substrate.
